(19) United States
(12) Patent Application Publication
(10) Pub. No.: US 2014/0377426 A1
(43) Pub. Date: Dec. 25, 2014

(54) AUTOMATIC PRODUCTION OF VARIOUS GRADES OF GROUND BEEF

(71) Applicant: SaafeFresh Technologies LLC, Mercer Island, WA (US)

(72) Inventor: Anthony J.M. Garwood, Mercer Island, WA (US)

(73) Assignee: SafeFresh Technologies, LLC, Mercer Island, WA (US)

(21) Appl. No.: 14/376,823

(22) PCT Filed: Feb. 6, 2013
(86) PCT No.: PCT/US13/24979

§ 371 Date: Aug. 5, 2014

Related U.S. Application Data
(60) Provisional application No. 61/595,537, filed on Feb. 6, 2012.

(51) Int. Cl. A23L 1/317; A23B 4/005

(52) U.S. Cl. CPC A23L 1/3177; A23B 4/005
USPC 426/417

(57) ABSTRACT

A method for producing various grades of beef is disclosed. The method includes, in two or more trains, creating a mixture of fat particles, lean particles, and a fluid, wherein each train is supplied with beef of varying fat content, for each train producing separate first and second fluid streams, wherein the first fluid stream comprises lean particles, and the second fluid stream comprises fat particles, for each train, adjusting the fat content of the lean stream by adding a controlled portion from the fat stream, separately treating the lean stream from the fat stream to deactivate pathogens, and producing two or more different grades of lean beef product.

### BACKGROUND

Retail ground beef is sold in supermarkets offering various grades of fat content, for example, ground beef may be sold as containing 93% lean (or more), 90% lean, 85% lean, 81% lean, 75% lean, and 73% lean or any other lean content selected by the supermarket. Consumer demand can vary widely, and therefore, it is impossible to predict the exact quantities of each grade of ground beef to meet current market needs.

Accordingly, it would be desirable to have a process that can efficiently accommodate the unpredictable variations of market demand for the multiplicity of packaged ground beef grades of various fat content.

### SUMMARY

A method for producing various grades of beef, includes, in two or more trains, creating a mixture of fat particles, lean particles, and a fluid, wherein each train is supplied with beef of varying fat content, for each train producing separate first and second fluid streams, wherein the first fluid stream comprises lean particles, and the second fluid stream comprises fat particles, for each train, adjusting the fat content of the lean stream by adding a controlled portion from the fat stream, separately treating the lean stream from the fat stream to deactivate pathogens, and producing two or more different grades of lean beef product.

The method may further include, before creating the mixture, dicing the beef supply, and chilling the diced beef pieces to cause water in lean matter to reduce in density.

The method may further include, after dicing and chilling, applying pressure to the chilled beef pieces to break off fat from the beef pieces to produce the fat particles and the lean particles.

The method may further include, after breaking off fat, adding fluid to the fat particles and lean particles to cause the water in lean matter to increase in density, and causing lean particles to sink in the fluid and fat particles to rise in the fluid.

The method may further include emulsifying fat particles after separation from the lean particles.

The method may further include centrifuging emulsified fat particles to separate fluid, and lean matter.

The method may further include pasteurizing the fat particles. The method may further include treating the lean particles with super critical carbon dioxide.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a flow diagram illustrating a method of producing various grades of ground beef from multiple sources of boneless beef;

FIG. 1B is a flow diagram illustrating a method of producing various grades of ground beef from multiple sources of boneless beef; and

FIG. 1C is a flow diagram illustrating a method of producing various grades of ground beef from multiple sources of boneless beef

### DETAILED DESCRIPTION

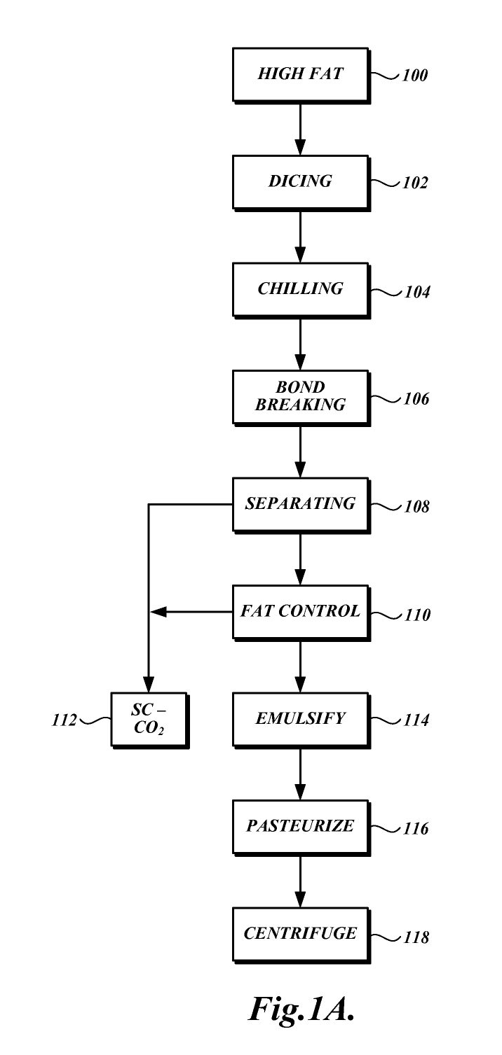

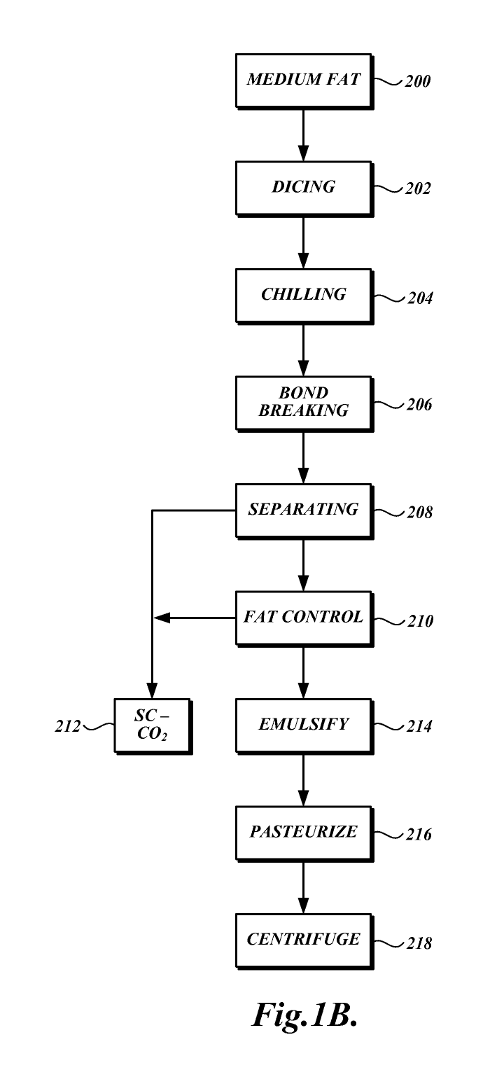

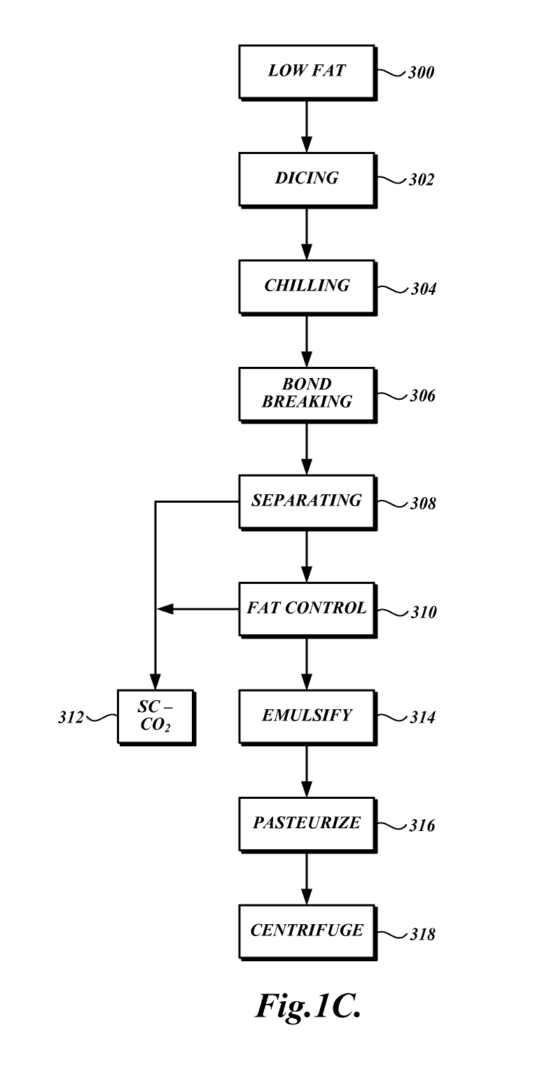

Referring to FIGS. 1A, 1B, and 1C, are flow diagram of a method for automatically producing various grades of ground beef. Ground beef can retail in supermarkets labeled as 93% lean, 90% lean, 85% lean, 81% lean, 75% lean, and 73% lean, to name a few examples. The illustrated method describes an automatic method for creating any grade of ground beef in accordance with the ever-changing demands of consumers with the minimum time period between issue of a Purchase Order by a Supermarket or other customer and the production of the specified ground beef grades.

In one embodiment of the system, the system is provided with three trains; however, fewer or more trains can be used. Each train includes substantially similar equipment, including at least dicing equipment, chilling equipment, separation equipment, crushing equipment, pathogen-deactivation equipment, and auxiliary equipment supporting each of these operations such as refrigeration.

Each of the three trains receives boneless beef, wherein each train receives different boneless beef according to fat content. Therefore, the average fat content of boneless beef processed in each train varies by train. In meat-processing plants and slaughterhouses, carcasses are disassembled or broken down and the boneless beef and trim is separated into industry standard groupings according to the fat content. In the industry, boneless beef having an average “chemical” lean of approximately 33% lean beef is generally referred to as XF's or “30s.” Boneless beef having approximately 50% lean beef is generally referred to as “50's.” Boneless beef having approximately 65% lean beef is referred to as “65's,” and so on, including up to “90's.” In one embodiment of the disclosed method, the 30's and the 50's are grouped and enter the high fat train 100. The 65's and 75's are grouped and enter the medium fat train 200, and the 85's and 90's are grouped and enter the low fat train 300. Each train has at least dicing, chilling, bond-breaking, and separating operations. These operations are also described in Application No. 61/493,876, fully incorporated herein expressly for all purposes. The aim of each train up to the separating block is to separate fat from lean beef and create two streams essentially one stream being fat and the other lean beef from each train.

Dicing blocks 102, 202, and 302 are for dicing and/or cutting the generally larger sections of beef into smaller pieces. Dicing and/or cutting may be done manually and/or alternatively, with dicing machines. In the dicing blocks, the beef may be in a nonfrozen condition. At this point, each diced beef piece may include fat and lean matter.

Chilling blocks 104, 204, and 304 are for chilling the diced beef pieces coming from the dicing blocks. In one embodiment, liquid carbon dioxide may be used for chilling in the chilling blocks. The chilled animal matter has both fat and lean matter. The chilling blocks result in differences in temperature between the fat and the lean matter on the same beef particle, such that the fat is at a temperature that can be separated from the lean by the application of pressure and can break free of the lean matter, and the lean is at a temperature that is pliable and does not result in the lean matter breaking free through the same application of pressure. However, the lean matter is chilled to a temperature at which water within the lean matter can freeze and expand, thus, reducing the density of such lean matter particles. For example, in one embodiment, the temperature of the beef pieces should be not more than 29° F. and preferably not less than 0° F. but most preferably about 15° F. to about 24° F. From the chilling blocks, the chilled beef pieces are sent to the bond-breaking blocks 106, 206, and 306. Up to this point, fat matter and lean matter are combined within the same beef particles. After bond breaking is applied to the beef pieces, some, if not most, of the fat breaks off from the beef particles resulting in fat particles, which are essentially all fat, and the remaining particles, which are comprised mostly of lean matter remaining on the beef particles.

Bond-breaking blocks 106, 206, and 306 are for liberating the fat matter from the beef pieces, which then leave beef pieces as essentially lean matter. The products of the bond-breaking blocks 106, 206, and 306 are particles essentially being all fat matter and particles comprising perhaps a majority of lean matter, but, fat may still be present in a minority quantity. The fat matter behaves quite differently to the lean matter, particularly when frozen to a temperature below about 25° F. to about 10° F. or lower, but not to such a low temperature that will cause the lean to become brittle. When reduced size beef pieces are frozen in this way, the fat can be shattered and will crumble providing a suitable means of separating the fat matter from the lean matter initially present in the beef pieces. Typically, this method of separation produces much smaller particles of fat while the lean particle size remains largely unaffected. It is therefore possible to separate lean from fat by freezing, shattering the fat matter, and then transferring the resultant stream of material through a vibratory sieve, which will allow the small fat particulates to pass through a sieve while transferring the larger lean pieces to another hopper; however, the sieve is not as effective as using the method of flotation in an anti-microbial carbonic acid.

The particles which are essentially all fat matter or essentially all lean beef matter are sent to the separating blocks 108, 208, and 308.

Before entering the separating blocks 108, 208, and 308, the particles which are essentially all fat matter or essentially all lean beef matter are combined with a fluid, such as a liquid. Representative fluids include, but are not limited to, water, a mixture of carbon dioxide and water that produces carbonic acid, fluid carbon dioxide, acids, alkaline agents, water with an acid, water with an alkaline agent, or any combination thereof. The temperature of the fluid may be controlled such as to affect the fluid density. In one embodiment, the fluid density is lower than the density of the particles which are essentially all lean beef. In one embodiment, the fluid density is higher than the density of the particles which are essentially all fat. In one embodiment, the fluid density is about the same as the density of the particles which are essentially all fat. In one embodiment, the fluid density is about the same as the density of the particles which are essentially all lean beef. In one embodiment, the fluid density is lower than the density of the particles which are essentially all lean beef and higher than the density of the particles which are essentially all fat. In one embodiment, the temperature of the fluid is higher than the temperature of the particles which are essentially all lean beef. In particular, the temperature of the fluid is higher than the temperature of the frozen water that is in the particles which are essentially all lean beef. A purpose to the fluid is to create stratification of different particles according to density. For example, the fat being less dense than lean beef will stratify and may float on the fluid, while the lean beef being more dense than fat will stratify below the fat layer. Also, when the water in the particles, which are essentially all lean beef, thaws, the density of the particles increases due to water being more dense than frozen water (ice). Accordingly, a purpose of the fluid is to thaw the frozen water, so as to make the particles that are essentially all lean beef more dense than the fluid and sink in the fluid.

The separating blocks separate the particles which are essentially all lean (the lean particles) from the particles which are essentially all fat (the fat particles). By adjusting the density of the fluid the fraction of lean particles to fat particles can be changed, so that increasing or decreasing the density of the fluid determines whether more or less fat particles are carried with the lean particles, thus providing a convenient way of adjusting the fat content of that portion of the lean particles. Various embodiments of apparatus may be used for separation. In one embodiment, the separating blocks may also separate the fluid from the particles.

Both the particles that essentially all lean and the particles that essentially all fat are entrained with the fluid, and at some point the fluid will need to be separated from the particles. For this purpose a second apparatus may be used to separate the fluid from particles based on density. An alternative way to separate fluid from the particles, which are solids, is through centrifugation.

Each of separating blocks 108, 208, and 308 result in at least two streams: first, a mixture of lean particles and fluid and, second, a mixture of fat particles and fluid. It is to be appreciated that small quantities of fat matter are still present in the lean particles. The fat matter may be attached to the lean particles, or some of the fat particles may have been entrained with the lean particles. The fat particles may also include a small quantity of lean matter, either as lean matter directly attached to fat or as separate lean particles.

Instruments may detect the content of fat in the lean stream immediately after the separating operation. Thereafter, if demand requires that the fat content be increased, a quantity of fat can be diverted and mixed with the lean beef product. The process may be computer controlled, such that readings of the fat content are continuous and can respond to changes in consumer demand.

Thereafter, the fat content controlled product and the fat product of each train can be treated for pathogen deactivation. As heat will damage the lean beef, a method employing supercritical or fluid carbon dioxide with low pH may be used to treat the lean beef product, while fat may be pasteurized via the application of heat. Pasteurizing by way of heat is thorough, complete, and very low cost whereas multiple phase supercritical and carbon dioxide treatment is more expensive, since the equipment is much more costly.

Furthermore, the majority of bacteria will be located on the fat because fat almost completely covers the outside of the carcass and a significant source of the bacteria is also on the hide. When the hide is pulled off, it is impossible to prevent all bacteria from being transferred to the fat cover of the carcass. The other significant source of bacteria is the gut. In theory, it should be possible to avoid puncturing the gut, but the task is an unpleasant occupation and few workers stick at it for long enough to become proficient at it. Hence, there is a big turnover and unskilled and untrained workers are inevitably put to work for relatively short periods. The knives used to separate the gut and other organs from the carcass are required to be exceedingly sharp so puncturing the gut is almost an inevitable occurrence. The inner surfaces of the abdominal cavity are also covered with a fat layer, consequently, by the time the animal is disassembled, and the outer fat layer removed, the major proportion of organisms initially on the carcass are transferred with the fat component, not the interior in the lean meat. Nevertheless, inevitably, bacterial organisms are transferred to the lean beef parts of the carcass.

In one example, the combined groups of 30s and 50s (representing about 35% of all boneless beef harvested) have an average lean content of about 45%. The initial separation of fat from lean, which does little damage to the lean, results in the two streams of beef, the first comprising about 38 parts of the 45 parts of the 45% lean plus 5 parts of the 45 parts comprises fat with the lean; and the second stream comprises about 50 parts of the 55 parts of the remaining 55% fat stream. If a higher fat content in the lean stream is required, an appropriate proportion of fat can be added to the lean stream. The remaining fat may be subjected to emulsification and then pasteurization, while the lean stream uses multiple phase supercritical and carbon dioxide for pathogen deactivation.

The fat stream can be emulsified and then pasteurized by heating to greater than 180° F., and a small, but nevertheless important, quantity of lean can be extracted from the fat stream by decanter or other suitable centrifuge. This small quantity of lean can be temperature reduced and recombined with the lean stream. The color of this lean component is detrimentally affected; but the quantity is small, and overall, the lean product is not affected.

By adopting the disclosed process, the production and processing capacity can be greatly increased for less cost than would otherwise be the cost for processing only by a supercritical carbon dioxide method that treats all the fat and the thoroughness of heat pasteurizing is a significant benefit particularly given the need to recombine the protein/lean (lean finely textured beef) with the lean stream.

The Dicing Blocks 102, 202, and 302

At the start of each train 100, 200, and 300, the boneless beef may be dumped into combo dumpers. From the combo dumpers, the beef is fed onto an inclined conveyor which delivers the beef to size reduction equipment and optionally a cutting table arranged to provide for manual cutting and reduction in size of beef pieces that are too large to be processed by the size reduction equipment. Beef may be boneless or may include bone and cartilage matter as well. Size reduction equipment may reduce the beef to pieces of approximately not bigger than 12″ in any dimension. After initial size reduction, dicing equipment is used to slice and dice the beef and reduce beef to a size preferably about 1 inch in cross section by 2 inches or less. While not limiting, the pieces are size reduced to approximately not more than about 1 inch wide and 2 inches long strips or 2 inch cubes. The individual pieces of diced beef may still contain an amount of fat and an amount of lean.

The Chilling Blocks 102, 202, and 302

From dicing equipment, diced beef pieces are chilled. In one embodiment, for example, the diced beef pieces are transferred on a conveyor through a tunnel freezer. A tunnel freezer may use carbon dioxide as the chilling medium. Carbon dioxide is admitted and extracted through conduits depending on whether the chilling operation is conducted concurrent or countercurrent with the flow of beef. The input temperature of the beef particles to the tunnel may be about 32° F. to 40° F., but preferably about 32° F. The temperature of the beef before the tunnel freezer may be controlled, in general, by adjusting the temperature of the room in which the beef is being diced. Owing to the differences of heat transfer between fat and lean in each beef piece, and respective amounts of water in lean versus fat matter, the chilling tunnel results in different temperatures of fat and lean within each beef piece.

It has been realized that the temperature of the individual particles that exit the chilling tunnel is not uniform throughout the pieces. Because of the different heat transfer rates of fat and lean as well as the different percentages of water within lean and fat, the temperature of the lean will be higher than the temperature of the fat, even of the same piece. The temperature reduction is carried out to result in lean matter that remains flexible due to the cohesive properties of muscle tissue, while the fat is cooler at the surface and is in a brittle and friable condition due to the lower temperature. However, because the lean contains greater amounts of water than fat, the water is frozen or partially frozen.

In one embodiment, flooding the tunnel enclosure with 100% carbon dioxide gas displacing what would otherwise be air is advantageous. In this way, carbon dioxide gas can be recycled through the evaporators. Another purpose in the use of carbon dioxide is to displace air (and therefore atmospheric oxygen), thereby inhibiting the formation of oxymyoglobin from the deoxymyoglobin exposed at the cut lean surfaces of each dice or beef piece when diced or sliced.

The temperature of the quickly frozen beef pieces when exiting the tunnel is controlled such that lean matter comprising substantially muscle striations, will freeze the water and all naturally-occurring fluids. Water represents about 70% of lean matter and thus the freezing and expansion of water when frozen contributes a significant increase in volume with a corresponding decrease in density of the lean matter. The beef pieces are in a solid phase but in such a way that the physical characteristics and properties of the lean matter is pliable and “rubbery” in texture, while the fat matter is friable such that it fractures when subjected to compressive and twisting actions and will crumble readily into small particles and be freed from the lean matter. The temperature to which the beef pieces are reduced needs to alter the physical condition of the beef pieces so as to facilitate the flexing of the muscle striations of the lean matter without causing it to fracture and break into smaller pieces, while simultaneously rendering the fat matter friable such that it will fracture, crumble, and break into smaller separate particles. In this way, the friable fat having broken away from the lean when it is flexed, crushed, bent, or twisted, thereby reduces the fat matter into small separated particles. Hence, these are referred to herein as fat particles. The part of the beef pieces remaining are relatively larger comprising mostly lean matter (because they are generally not broken into small particles). Hence, these are referred to herein as lean particles. The change in physical breakdown of the beef pieces into two types of particles is caused by lowering the temperature thereof followed by physical disruption of the bond, which fixes the fat and lean matter together in an attached state, and results in a size difference between the larger lean particles compared to smaller fat particles.

It has been found that by reducing the temperature of the beef pieces with fat to a range of between less than 29° F. and above 26° F., the process described above will facilitate separation by providing friable fat fractures permitting the fat to crumble into small particles, leaving the lean matter as larger particles.

The tunnel freezer may be a cryogenic freezer using nitrogen or carbon dioxide as the refrigerant, such that upon transfer out of the freezing tunnel (or other style of freezer) the temperature of the fat (at its surface) is lower than the temperature of the lean in each separate piece of beef. In one embodiment, the beef pieces are temperature reduced by transfer through a tunnel freezer such that the surface temperature of the fat matter is lower (approximately 5° F.) than the surface temperature of the lean matter, which is shown to be about 29° F., immediately following discharge from the freezer. The temperature at the surface of fat may be at about 5° F. or less and up to 10° F. or more such that it can be friable and crumble upon application of pressure, while the temperature of the lean may be 16° F. to about 34° F., or alternatively below 29° F., which makes the lean flexible and not frozen into a “rock-hard” condition immediately after removal from the freezing process.

The above description of creating friable fat prone to crumble is attributed to the respective differences in the heat transfer ability of fat compared to lean. Referring to TABLE 1 below, the temperature of the lean and fat matter is separately plotted against elapsed time. As can be seen, the temperature of the lean matter is above the temperature of the fat matter for about 5 minutes subsequent to discharge from the freezer and at about 6 minutes (after discharge from the freezer) the lean temperature is lower than the fat temperature.

In one embodiment, immediately after leaving the tunnel freezer, the fat can be at a temperature of 5.2 F. (at the surface), while the lean is at a temperature of 29 F. This difference in temperature is attributed to the respective heat conductive properties of fat versus lean. The individual pieces of beef containing both fat and lean are exposed to the freezer on the order of minutes, generally, between 2 and 3 minutes to create friable fat matter prone to crumble under a crushing force, whereas the lean remains pliable, flexible and not prone to crumble under a similar crushing force. The temperatures will then begin to converge to equilibrium; therefore, it is useful to process the pieces of beef in the bond breaking compression device before the fat is no longer friable and easy to crumble.

TABLE 1
Temperature Difference of Fat and Lean

| | | | | | Temperature | |
|---|---|---|---|---|---|---|
| | Date | Time | delta T′ | delta T | Fat | Lean |
| 1 | Aug. 3, 2010 | 3:31:00 PM | 0:00 | 0:00 | 5.2 | 29.0 |
| 2 | | 3:37:00 PM | 0:06 | 0:06 | 27.9 | 26.6 |
| 3 | | 3:43:00 PM | 0:06 | 0:12 | 29.5 | 26.9 |
| 4 | | 3:50:00 PM | 0:07 | 0:19 | 30.9 | 27.8 |
| 5 | | 3:58:00 PM | 0:08 | 0:27 | 29.7 | 28.6 |
| 6 | | 4:03:00 PM | 0:05 | 0:32 | 30.6 | 28.9 |
| 7 | | 4:14:00 PM | 0:11 | 0:43 | 31.0 | 29.5 |
| 8 | | 4:22:00 PM | 0:08 | 0:51 | 32.8 | 29.8 |
| 9 | | 4:31:00 PM | 0:09 | 1:00 | 33.3 | 30.0 |
| 10 | | 4:36:00 PM | 0:05 | 1:05 | 35.3 | 30.0 |

The Bond-Breaking Blocks 106, 206, and 306

The stream of temperature reduced beef pieces from the chilling blocks 104, 204, and 304 can be immediately, without storing in containers or otherwise that could allow temperature equilibration of the fat and the lean matter, or on an extended conveyor, be transferred through a bond breaking process during which the beef pieces are “flexed” or bent by distortion and partially crushed as they are transferred between, for example, a pair (two) of parallel rollers manufactured from any suitable stainless steel such SS316 or SS304 grades, but wherein the beef pieces are not completely flattened as would occur if placed on a hard surface and rolled upon with a very heavy roller (steam/road roller for example). This bond breaking compression process is intended to cause breakage of the friable fat matter into smaller particles of, in the majority of instances, approximately 100% fatty adipose tissue (fat) and smaller than the fat matter was before transfer through the bond breaking process and much more so than the lean matter which remains in most cases intact but without any more than about 10% fat, or less, remaining attached to the majority of lean matter after transfer through the bond breaking process. In other words, the fat in the beef pieces will “crumble”, fracture, and break into small particles and separate from the lean in a continuous stream of what becomes small (smaller than before transfer through the crushing process) fat particles and lean particles that still comprise some fat, but are approximately more than 90% lean beef

A bond breaking device may comprise at least one or more pairs of horizontally disposed and opposed specially manufactured rollers, arranged so that one pair is above the other, such that the stream of beef pieces spread out across the full width of the tunnel conveyor and are dropped in a waterfall effect between the upper pair of rollers which clamp the particles and flex so as they are transferred between the clamping rolls without crushing and in this way cause the friable fat matter attached to any flexible lean matter to break away in small particles.

Following the bond breaking process, the beef pieces, once a combination of lean and fat matter, are now smaller particles of predominantly all fat and predominantly all lean owing to the breaking of the fat. The lean particles and the fat particles are next separated. Separation may be done in cycles. The lean particles and the fat particles can be accumulated in a hopper until a sufficient amount has been collected to provide for the next separation cycle in the separation equipment. Alternatively, the disclosed methods enable the separation of fat particles from the lean particles in a continuous stream but allow the separation of lean particles to occur when, at least, part of the particles remain in a frozen condition while the remaining part of the particle is an unfrozen condition and to then as quickly as can be achieved, separate the lean particles from the liquid carbonic acid which carries the lean particles along a low elevation conduit branch.

The Separating Blocks 108, 208, and 308

In general, separation of the fat particles from the lean (having some fat) particles is done by way of buoyancy separation in a fluid that has a density lower than that of the lean particles, when the water in the lean particles is not frozen. Separation may also be conducted with a fluid that has a density greater than that of the fat particles. Separation may also be conducted with a fluid that has a density in the range between the fat particles and the lean particles. The fluid can include water, or water with carbon dioxide, which results in the production of carbonic acid. The fluid can include acids or alkaline agents, either alone, with carbon dioxide, fluid carbon dioxide, or with water.

At the temperatures required for bond breaking discussed above, when the fluid is first mixed with the lean and fat particles, the particles including the lean particles, will float and be suspended at the uppermost space available in the fluid and just below a surface of the fluid or suspended within the fluid. As the temperature of the fluid and fat and lean particles begins to equilibrate, which involves the initial lower temperature of the lean particles increasing (corresponding with the decreasing temperature of the fluid), the buoyancy of the lean particles will start to “fail” until the lean particles sink toward the base of the fluid leaving the fat particles floating at the fluid surface or uppermost available space in the fluid. An increase in the density of the lean particles is seen as the water in the lean particles thaws, which reduces the volume of lean particles and correspondingly increases the density. Fat having a lower content of water does not experience as great an increase in density due to water thawing.

Before and during the lean particles and fat particles have reached equilibrium with the fluid, any bone chips that may be present will sink when mixed together with the fluid, thereby providing a convenient means of separating bone chips first, which will most preferably be arranged to occur immediately after blending the lean and fat particles with the fluid and before temperature equilibration of the particles or when the lean particle temperature has increased so as to thaw the lean/water content of the lean matter upon which shrinkage of the lean will occur causing it to sink in the fluid. The fat particles, frozen or not, will remain floating at the fluid surface. By lowering the fluid temperature relative to the temperature of the lean particles, complete thawing and temperature equilibration will be delayed and, accordingly, the lean particles will remain suspended for a longer period and this can assist with UVc pathogen deactivation because of the suspension in fluid.

Separation of a fluid mixture comprising predominantly lean particles and predominantly fat particles into two streams results in a first high percentage lean content stream (comprising for example 93% +/−<1.0% lean with the balance being fat) and a second fat stream of high fat content (comprising about 85% fat with the balance being lean).

Table 2 (below) lists the densities of; firstly, several beef components including bone, lean beef, fat and cartilaginous bone, at both above and below the respective frozen condition; and also carbonic acid and water. It can be seen that the densities of the frozen, water-containing beef components of lean and fat have lower densities compared to their respective unfrozen condition. This physical variation is because water expands when it freezes. The temperature at which beef freezes is at about 29° F. or below. Beef fat will float in water or carbonic acid, or other fluid, whether it is in frozen condition or not but, as can be seen in Table 1, frozen lean beef having a density of about 59 lbs per cubic foot will float in water and/or carbonic acid which have densities of about the same value, about 63 lbs per cubic foot; however, when the lean beef is not frozen, its density increases to about 65 lbs per cubic foot and therefore will sink when suspended in water or carbonic acid. Furthermore, the introduction of initially frozen water-containing beef into such fluids at a higher temperature than the frozen beef will cause suspension or floating of the beef initially. As the temperatures equilibrate, this causes thawing of the water in the beef with an attendant decrease in volume and increase in density, which will cause the beef or lean to sink in the fluid. Neither bone nor cartilaginous bone contain significant quantities of water and their respective densities are not significantly affected by freezing followed by thawing; both are more dense than fat or lean beef.

The separation methods described herein employ the density variations described above to provide an effective method of dividing a quantity of beef into fractions comprising the separated components of bone, lean beef and beef fat. Beef is used only for purposes of illustrating embodiments of the invention; it is to be appreciated that other meats, including pork, chicken, and fish may also be used in the disclosed methods. Furthermore, bone or cartilaginous bone may or may not be present in some embodiments.

TABLE 2

| | | | |
|---|---|---|---|
| Physical | Density | % Water | Density |
| Matter | @ 4° C. | Content | when frozen |

| | | | | | |
|---|---|---|---|---|---|
| Bone | 118.6 | lbs/cu′ | 0% | 118.6 | lbs/cu′ |
| Cartilage | 80 | lbs/cu′ | 0% | 80 | lbs/cu′ |
| Lean Beef | 64 | lbs/cu′ | 59% | 59.6 | lbs/cu′ |
| Lean Beef | 64 | lbs/cu′ | 73% | 58.6 | lbs/cu′ |
| Carbonic Acid | 63 | lbs/cu′ | 70% | 58 | lbs/cu′ |
| Water | 62 | lbs/cu′ | 100% | 57 | lbs/cu′ |
| Ice | 57 | lbs/cu′ | 100% | 57 | lbs/cu′ |
| Beef Fat | 55 | lbs/cu′ | 11% | 54.5 | lbs/cu′ |

APPROXIMATE DENSITIES & WATER CONTENT OF SPECIFIED MATTER

Separation may be done in enclosed conduits. Generally, any conduit or vessel having a way of collecting the fat particles at an upper section of the conduit or vessel and a way of collecting the lean particles remaining after the collection of the fat particles.

In one embodiment, a separation apparatus includes a vertical column followed by a separation manifold, or horizontal column, which then divides into at least two conduit branches, wherein one conduit branch is a lower elevation conduit branch and a second conduit branch is at a higher elevation. In this embodiment, a fluid mixture of still partially frozen particles (mostly/only fat and mostly/only lean) is directed down into the vertical column. The vertical column then connects to the separation manifold, of which there are several embodiments, any one of which may be used and are interchangeable. Furthermore, the separation equipment need not be a manifold. As an alternative to a manifold, other separation vessels may be used. The mixture traveling through the vertical column is combined with a pressurized stream of fluid. As fluids, liquid carbonic acid, water, acids, and alkaline fluids may be used.

As described further below, the mixture comprising lean particles, fat particles, and liquid carbonic acid (or other fluid) are separated into components. The fat is separated and extracted from the fluid and processed, optionally, through a particle size reducing apparatus such as a bowl chopper or an emulsifier used to break the cell walls but at this stage in the separation process, the fat particles in the fat stream will be size reduced, but not to the extent of breaking cell walls, but only so as to ensure all red and white colored lean still present with the fat is recovered.

The mixture of particles and fluid are blended together in the vertical column connected and the temperatures begin to equilibrate. Any heavy bone fragments, which are unaffected by the water freezing temperatures, sink immediately to the lowermost location in the manifold it can fall to, which, in one embodiment, is arranged to be located at the base of the vertical column. From the vertical column, the conduit may be diverted horizontally. In one embodiment, for example, the bone matter may be collected at a bend from the vertical column to the horizontal conduit.

As the mixture of solids and liquid carbonic acid are transferred along the horizontal conduit (“manifold”), temperature equilibration between the solids and liquid increases the density of the high-water-content lean matter as the formerly frozen water thaws and shrinks The lean and fat solids quickly separate as temperature equilibration occurs, causing the density of lean to increase causing the fat and lean solids to diverge as they are carried with the flow of fluid along the horizontal conduit. The fat matter remains buoyant, carried by the fluid at a higher elevation than the lean matter and the lean particles fall to the lowermost section of the conduit through which they are still propelled along the horizontal conduit by the flow of fluid. The separation manifold is constructed so that following temperature equilibration of the particles, a conduit connected directly to the underside of the horizontal separation manifold and extending downward, allows the lean particles to be separated from the main fluid stream. An opposing conduit, attached directly to the upper side of the horizontal conduit, allows the fat particles to diverge upwardly and in this way, the fat and lean particles are divided into two streams, wherein the lean particles and fluid flow in one conduit and, the fat particles and fluid flow in a separate and higher conduit.

A manifold as used herein when referring to a separator takes the form of a conduit that branches from a main conduit transferring the mixture of fluid, fat and lean particles into at least two or more conduit branches. The two or more conduit branches are, respective to each other, different in elevation, so that matter that is lower in the main conduit may be transferred to the low conduit branch, while matter that is higher in the main conduit is transferred to the higher conduit branch.

The first stream contains fluid and the majority of the lean particles, and the second, contains fluid and the majority of the fat particles. It is to be appreciated that at this stage of separation, small amounts of lean particles may be entrained in the fluid stream of fat particles, and small amounts of fat may be entrained in the fluid stream of lean particles. Indeed, the retention of some fat, and preferably a desired content of fat content in the fluid stream of lean particles, is desirable to produce a lean product of desired fat content. The fat may also be present on lean particles that fail to separate from the lean matter during the bond breaking process.

Fat Control Blocks 110, 210, 310

The ability to measure the fat content of beef matter within a fluid is based on the realization that the density of a fluid with solid matter correlates to a fat percentage. The fat content of any beef matter, regardless whether the beef is predominantly lean matter or fat matter, can be determined by knowing the density of the combined fluid and solid matter. In one embodiment, a correlation table can be created that correlates density with fat percent. The table may be created empirically after conducting numerous trials. The table may be stored in a storage device, such as computer memory, or databank. In one embodiment, the instruments that measure density are known as coriolis instruments. Coriolis measuring instruments, as used herein, are capable of measuring massflow, density and temperature. Instead of using a single measurement of massflow, an average may be taken of a plurality of measurements over a time period. Density is determined from massflow by dividing the massflow by a known volume in the instrument. Accordingly, since massflow includes the mass of the fluid and of any solids, the density is not the density of the fluid nor solids, but the density of the mixture of fluid with solids. Once the density is known, the fat content can be ascertained through a correlation table. It is to be appreciated that the fluid has no fat content, thus, the fat content that is ascertained refers to the fat content of the solid matter within the fluid. Accordingly, once the fluid is separated, the fat content remains the same.

The two streams of lean matter and fat matter after being separated can be measured for fat content. The conduits in which the respective streams of fat particles and lean particles travel can be measured by flow measuring instruments, such as coriolis instruments, as described above to determine the fat content. If it is determined that the fat content of the lean is too low, or if the fat content is not as expected, the percentage of fat of the lean stream can be controlled. By way of example, the fat content in the lean stream can be controlled by removing more or less fat in the second higher elevation conduit, thus, allowing more or less fat to enter with the lean matter in the lower elevation conduit. This is accomplished by either adjusting the density of the fluid to shift the buoyancy point, or by physically restricting fat from leaving through the elevated conduit, such as via a pump. For example, the massflow of the fat/fluid stream can be controlled by a pump with a variable frequency drive electric motor that can operate in the following manner. The lean/fluid stream is measured to determine a fat content (which may be approximately 7%, 8% or 9%), then, if the target is to produce 85% lean, the fat/fluid stream massflow is restricted so that more of the fat/fluid stream must flow into the lean/fluid stream to add, say an additional 8% fat, and when this lower target value (84% lean) is measured (based on the density/fat correlation table), the pump is opened to allow more fat to be transferred away from the lean/fluid stream. When a higher target value, say 86% lean, is measured by the measuring instrument, the pump is opened so as to add just 6% additional fat. In this way, a harmonic motion or cycle can be created wherein the upper limit fat content is 16% and the lower limit fat content is 14% and this “cycle can be continuously repeated.

Alternatively, the separated second stream of fat can be divided into a measured third stream of the initial second stream of fat. The mass of the measured third stream division can be adjusted by varying the quantity transferred in the third stream. The measured third stream of fat can then be recombined with the entire first stream of lean such that the relative proportions of fat and lean after recombining provide a single recombined stream with fat and lean content proportions according to a selected ratio. In other words, for example, by accurately measuring the fat stream division, the resultant lean content of the recombined stream can be any value less than the lean content (93% +/−<1.0% lean) of the first lean stream. A recombined stream lean content of 81%, 85%, 90% or any other value can be produced in this way.

Furthermore, since the disclosed process uses three trains, each initially being of different fat content material, the disclosed process provides for much greater flexibility of producing any grade of desired fat content.

Fat Emulsification Blocks 114, 214, 314

The fat stream that remains after some fat has been transferred to the lean stream may be emulsified in blocks 114, 214, and 314. One example of an emulsifying device is a device that has a high shear-producing member placed in the path of fluid carrying particles comprising fat. For example, forcefully pumping the fat stream through a narrow passage having sharp edges can produce the required high shear needed to emulsify the fat. Passing the fat through a narrow opening can induce very high shear forces that will cause any fat to be scraped or removed from the larger solid particles. Other devices used for emulsification may rely on high pressure drops to create high shear forces.

Pasteurization Blocks 116, 216, 316

After emulsification, fat can be treated for destruction of pathogens. The well known method of pasteurization may be used. As heat will damage the lean beef, a method employing supercritical or fluid carbon dioxide with low pH may be used to treat the lean beef product, while fat may be pasteurized via the application of heat. Pasteurizing by way of heat is thorough, complete, and very low cost whereas multiple phase supercritical and carbon dioxide treatment is more expensive, since the equipment is much more costly. The fat stream can be pasteurized by heating to greater than 180° F., and a small, but nevertheless important, quantity of lean can be extracted from the fat stream by decanter or other suitable centrifuge in centrifuge blocks 118, 218, and 318. This small quantity of lean can be temperature reduced and recombined with the lean stream. The color of this lean component is detrimentally affected; but the quantity is small, and overall, the lean product is not affected.

Pathogen Deactivation of Lean Blocks 112, 212, 312

Blocks 112, 212, and 312 are pathogen deactivating blocks for treating the lean particles after the separation blocks 108, 208, and 308. A number of different pathogen deactivation technologies may be employed. For example, in one embodiment, supercritical carbon dioxide may be used.

A vessel having one or more reciprocating pistons may be used to create supercritical carbon dioxide. The piston elevates carbon dioxide pressure to above the critical pressure and temperature of carbon dioxide. Supercritical carbon dioxide can be used reduce the activity of any microorganisms are present on the lean particles. The pressure within such vessel can be cycled between a low and higher pressure exceeding the critical pressure and temperature of carbon dioxide a plurality of times until the microorganisms are reduced to an acceptable level. Other methods for deactivating pathogens on beef without detrimentally affecting the quality are described in U.S. Pat. No. 8,101,220, incorporated by reference in its entirety.

The process blocks of FIG. 1 are not limited to being performed in any particular sequence. Some steps may be omitted and substituted for one or more steps that perform the similar function or are arranged in a different sequence to perform the similar function. Some steps may be omitted that are merely ancillary or embraced as a subsystem of the illustrated steps. The disclosed method can be described by the following embodiments.

A method for producing various grades of beef, includes, in two or more trains, creating a mixture of fat particles, lean particles, and a fluid, wherein each train is supplied with beef of varying fat content, for each train producing separate first and second fluid streams, wherein the first fluid stream comprises lean particles, and the second fluid stream comprises fat particles, for each train, adjusting the fat content of the lean stream by adding a controlled portion from the fat stream, separately treating the lean stream from the fat stream to deactivate pathogens, and producing two or more different grades of lean beef product.

The method may further include, before creating the mixture, dicing the beef supply, and chilling the diced beef pieces to cause water in lean matter to reduce in density.

The method may further include, after dicing and chilling, applying pressure to the chilled beef pieces to break off fat from the beef pieces to produce the fat particles and the lean particles.

The method may further include, after breaking off fat, adding fluid to the fat particles and lean particles to cause the water in lean matter to increase in density, and causing lean particles to sink in the fluid and fat particles to rise in the fluid.

The method may further include emulsifying fat particles after separation from the lean particles.

The method may further include centrifuging emulsified fat particles to separate fluid, and lean matter.

The method may further include pasteurizing the fat particles.

The method may further include treating the lean particles with super critical carbon dioxide.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for producing various grades of beef, comprising:
in two or more trains, creating a mixture of fat particles, lean particles, and a fluid, wherein each train is supplied with beef of varying fat content;
for each train, producing separate first and second fluid streams, wherein the first fluid stream comprises lean particles and the second fluid stream comprises fat particles;
for each train, adjusting the fat content of the lean stream by adding a controlled portion from the fat stream;
separately treating the lean stream from the fat stream to deactivate pathogens; and
producing two or more different grades of lean beef product.

2. The method of claim 1, further comprising, before creating the mixture, dicing the beef supply, and chilling the diced beef pieces to cause water in lean matter to reduce in density.

3. The method of claim 2, further comprising, after dicing and chilling, applying pressure to the chilled beef pieces to break off fat from the beef pieces to produce the fat particles and the lean particles.

4. The method of claim 3, further comprising, after breaking off fat, adding fluid to the fat particles and lean particles to cause the water in lean matter to increase in density, and causing lean particles to sink in the fluid and fat particles to rise in the fluid.

5. The method of claim 1, further comprising emulsifying fat particles after separation from the lean particles.

6. The method of claim 5, further comprising centrifuging emulsified fat particles to separate fluid, and lean matter.

7. The method of claim 1, wherein the fat particles are pasteurized.

8. The method of claim 1, wherein the lean particles are treated with super critical carbon dioxide.
